(19) United States
(12) Patent Application Publication
(10) Pub. No.: US 2021/0088042 A1
(43) Pub. Date: Mar. 25, 2021

(54) SEMI-TRAILER-LOADED TURBINE FRACTURING EQUIPMENT

(71) Applicant: YANTAI JEREH PETROLEUM EQUIPMENT & TECHNOLOGIES CO., LTD., Yantai (CN)

(72) Inventors: Rikui Zhang, Yantai (CN); Sheng Chang, Yantai (CN); Peng Zhang, Yantai (CN); Chunqiang Lan, Yantai (CN); Yipeng Wu, Yantai (CN); Xincheng Li, Yantai (CN); Xiance Li, Yantai (CN)

(21) Appl. No.: 16/838,806

(22) Filed: Apr. 2, 2020

(30) Foreign Application Priority Data
Sep. 20, 2019 (CN) 201910894342.5

(51) Int. Cl. F04B 47/04; F04B 17/06; E21B 43/26; F16H 1/28

(52) U.S. Cl. CPC F04B 47/04; F04B 17/06; F04B 53/08; F16H 1/28; F04B 2203/11; E21B 43/2607

(57) ABSTRACT

The present invention discloses a semi-trailer-loaded turbine fracturing equipment, which adopts a linear connection of the whole equipment and a special chassis design, so that the center of gravity is double lowered to guarantee its stability and safety, the structure is simpler, the investment and operation costs are decreased, the risk of total breakdown of the fracturing site is reduced, and the equipment has a good transmission performance and is suitable for continuous operation conditions with long time and heavy load. The plunger pump is improved in that the distance between the center of rotation of the bellcrank and the center of rotation of the crankshaft is optimized so that the rated input power is increased to 5000-7000 hp, the transmission ratio of the reduction gearbox integrated on the plunger pump is optimized so that the maximum input speed can reach 16000 rpm, the superhigh speed allows the reduction gearbox to be connected directly to the turbine engine to address the problem that the turbine fracturing equipment is decelerated through two reduction gearboxes, thus decreasing the weight of the vehicle and reducing the overall size of the equipment.

### TECHNICAL FIELD

The present invention relates to the technical field of turbine fracturing, and specifically to a semi-trailer-loaded turbine fracturing equipment.

### BACKGROUND

In the working sites of fracturing in oil and gas fields all over the world, the driving modes for fracturing equipment mainly include the following two ways:

One driving mode is diesel engine driven, specifically a diesel engine is connected to a transmission through a transmission shaft to drive the fracturing plunger pump to work. In other words, a diesel engine is used as the power source, a transmission and a transmission shaft are used as the transmission devices, and a fracturing plunger pump is used as the actuating element.

This configuration mode has the following disadvantages:

(1) Large volume and heavy weight: When a diesel engine drives a transmission to drive a fracturing plunger pump through a transmission shaft, a large volume is occupied, a heavy weight is involved, the transportation is restricted, and the power density is low;

(2) Environmental problems: During operations on a well site, the fracturing equipment driven by the diesel engine would generate engine waste gas pollution and noise pollution. The noise exceeding 105 dBA will severely affect the normal life of nearby residents;

(3) Cost inefficiency: The fracturing equipment driven by the diesel engine requires relatively high initial purchase costs and incurs high fuel consumption costs for unit power during operation, and the engine and the transmission also require very high routine maintenance costs.

The other driving mode is electric drive fracturing, specifically an electric motor is connected to a transmission shaft or a coupling to drive the fracturing plunger pump to work. In other words, an electric motor is used as the power source, a transmission shaft or a coupling is used as the transmission device, and a fracturing plunger pump is used as the actuating element.

Although the electric drive fracturing has many advantages itself, the power supply on fracturing well sites is the prerequisite for implementation of electric drive fracturing. Generally, it is difficult to supply power for the fracturing well sites in that the power capacity on the well sites is too small to drive the whole fracturing unit, or there are not any power networks at all on the well sites. Therefore, in common electric drive fracturing sites, generators are generally used to generate electricity. The most economical generation fuel is natural gas, but the users employing natural gas need to rent or purchase gas generator sets. For a fracturing well site without power networks, the power of the gas generator sets needs up to at least 30 MW. Purchasing such high-power gas generator sets is a great investment for customers. More importantly, in actual work progress, the accidental shutdown of the gas generator sets would cause the breakdown of the whole electric drive fracturing unit, thus seriously affecting the working quality, even causing work accidents possibly.

Therefore, there is an urgent need for a new fracturing equipment to solve the disadvantages of the above existing diesel engine-driven fracturing and electric drive fracturing, thus better satisfying the demands on the oil and gas field fracturing market globally.

### SUMMARY

To overcome the deficiencies in the prior art, an objective of the present invention is to provide a semi-trailer-loaded turbine fracturing equipment, which adopts a linear connection of the whole equipment and a special chassis design, so that the center of gravity is double lowered to guarantee its stability and safety, the structure is simpler, the investment and operation costs are decreased, the risk of total breakdown of the fracturing site is reduced, and the equipment has a good transmission performance and is suitable for continuous operation conditions with long time and heavy load. The plunger pump is improved in that the distance between the center of rotation of the bellcrank and the center of rotation of the crankshaft is optimized so that the rated input power is increased to 5000-7000 hp, the transmission ratio of the reduction gearbox integrated on the plunger pump is optimized so that the maximum input speed can reach 16000 rpm, the superhigh speed allows the reduction gearbox to be connected directly to the turbine engine to solve the problem that the turbine fracturing equipment is decelerated through two reduction gearboxes, thus decreasing the weight of the vehicle and reducing the overall size of the equipment.

The objective of the present invention is achieved by the following technical measures: a semi-trailer-loaded turbine fracturing equipment, including a transporter, an exhaust system, a turbine engine and a plunger pump; the exhaust system is connected to an exhaust port of the turbine engine, an output end of the turbine engine is connected directly to the plunger pump, the transporter is used to support the exhaust system, the turbine engine and the plunger pump; the plunger pump includes a power end assembly, a hydraulic end assembly and a reduction gearbox assembly; one end of the power end assembly is connected to the hydraulic end assembly, the other end of the power end assembly is connected to the reduction gearbox assembly; the reduction gearbox assembly includes a planetary reduction gearbox and a parallel reduction gearbox, the planetary reduction gearbox is used in conjunction with the parallel reduction gearbox, with a transmission ratio of 60:1 to 106:1.

Further, the exhaust system, the turbine engine and the plunger pump are disposed in a straight line along the transmission direction of power.

Further, there are two planetary reduction gearboxes, including a first planetary reduction gearbox and a second planetary reduction gearbox; one end of the first planetary reduction gearbox is connected to the power end assembly, the other end of the first planetary reduction gearbox is connected to the parallel reduction gearbox, and the other end of the parallel reduction gearbox is connected to the second planetary reduction gearbox.

Further, the planetary reduction gearbox includes one sun gear, four planetary gears and one gear ring, the four planetary gears form a planetary gear mechanism, the sun gear is located at the center of the planetary gear mechanism, the planetary gears and the adjacent sun gear and gear ring are in a normally engaged state; the parallel reduction gearbox includes a pinion and a bull gear, the pinion is coaxial with the sun gear of the first planetary reduction gearbox, and the bull gear is coaxial with the sun gear of the second planetary reduction gearbox.

Further, an input angle of the reduction gearbox assembly can be adjusted according to input requirements.

Further, the other end of the power end assembly is connected to the reduction gearbox assembly through a spline or a flexible coupling.

Further, the power end assembly includes a crankcase, a crosshead case and a spacer frame; one end of the crosshead case is connected to the crankcase, the other end of the crosshead case is connected to the spacer frame; the hydraulic end assembly is disposed at one end of the spacer frame and is connected to the crankcase through bolts sequentially passing through the spacer frame and the crosshead case; the reduction gearbox assembly is connected to the crankcase through bolts, a crankshaft in the crankcase is forged from alloy steel and includes six axle journals and five bellcranks, one bellcrank is disposed between every two adjacent axle journals, and the distance between the center of rotation of the bellcrank and the center of rotation of the crankshaft is 120 to 160 mm.

Further, the transporter includes a chassis which is provided with a transport section, a bearing section and a lapping section which are connected in sequence; while the turbine fracturing equipment is in working state, the bearing section of the chassis can contact with the ground, while the turbine fracturing equipment is in transport state, the bearing section of the chassis does not contact with the ground.

Further, the transporter includes wheels and axles, the wheels are disposed at both ends of the axles, the axles are connected to the chassis, and the number of the axles is 3 or above.

Further, while the turbine fracturing equipment is in working state, the bottom of the bearing section of the chassis is at the same level as the bottom of the wheels.

Further, the bottom of the lapping section is provided with a bevel which is provided with a bulge, while the turbine fracturing equipment is in transport state, the bevel can be used in conjunction with external towing equipment, the bulge assists in fixing the transporter and preventing the transporter from separating from the external towing equipment.

Further, the transporter is provided with a hydraulic power unit which is used to drive the hydraulic system on the turbine fracturing semi-trailer.

Further, the hydraulic power unit is driven by a diesel engine or driven by an electric motor.

Further, the transporter is provided with a cooling system which cools the oil used on the turbine fracturing semi-trailer.

Compared with the prior art, the present invention has the following beneficial effects: firstly, the exhaust system, the turbine engine and the plunger pump are disposed in a straight line along the transmission direction of power, which replaces the upper and lower structure setting in the existing equipment, so that the center of gravity of the whole equipment is lowered; secondly, a special design of the chassis allows the center of gravity of the equipment to be double lowered to guarantee its stability and safety, the transportation is more convenient, the structure is simpler, the investment and operation costs are decreased. Arranging in a straight line, the equipment has a good transmission performance and is suitable for continuous operation conditions with long time and heavy load. Driving a single plunger pump with a single turbine engine, the risk of total breakdown of the fracturing site is reduced. The plunger pump is improved in that the distance between the center of rotation of the bellcrank and the center of rotation of the crankshaft is optimized so that the rated input power is increased to 5000-7000 hp, the transmission ratio of the reduction gearbox integrated on the plunger pump is optimized so that the maximum input speed can reach 16000 rpm, the superhigh speed allows the reduction gearbox to be connected directly to the turbine engine to address the problem that the existing turbine fracturing equipment is decelerated through two reduction gearboxes, thus decreasing the weight of the vehicle and reducing the overall size of the equipment.

The present invention will be described in detail below with reference to the accompanying drawings and specific implementations.

### BRIEF DESCRIPTION OF THE DRAWINGS

FIG. 1 is a schematic structural diagram of a semi-trailer-loaded turbine fracturing equipment.

FIG. 2 is a diagram showing the transport state of a semi-trailer-loaded turbine fracturing equipment.

FIG. 3 is a schematic structural diagram of a plunger pump.

FIG. 4 is a schematic structural diagram of a reduction gearbox assembly.

FIG. 5 is a sectional view of a planetary reduction gearbox.

FIG. 6 is a sectional view of a parallel reduction gearbox.

FIG. 7 is a schematic structural diagram of a power end assembly.

FIG. 8 is a schematic structural diagram of a crankshaft.

Wherein, 100. hydraulic power unit, 200. transporter, 210. bevel, 220. bulge, 230. horizontal surface, 240. slope surface, 300. exhaust silencer, 400. exhaust duct, 500. turbine engine, 600. plunger pump, 700. tractor, 1. power end assembly, 2. hydraulic end assembly, 3. reduction gearbox assembly, 4. crankcase, 5. crosshead case, 6. spacer frame, 7. axle journal, 8. bellcrank, 9. the first planetary reduction gearbox, 10. parallel reduction gearbox, 11. the second planetary reduction gearbox, 12. bull gear, 13. pinion, 14. planetary gear, 15. gear ring, 16. sun gear.

### DESCRIPTION OF THE EMBODIMENTS

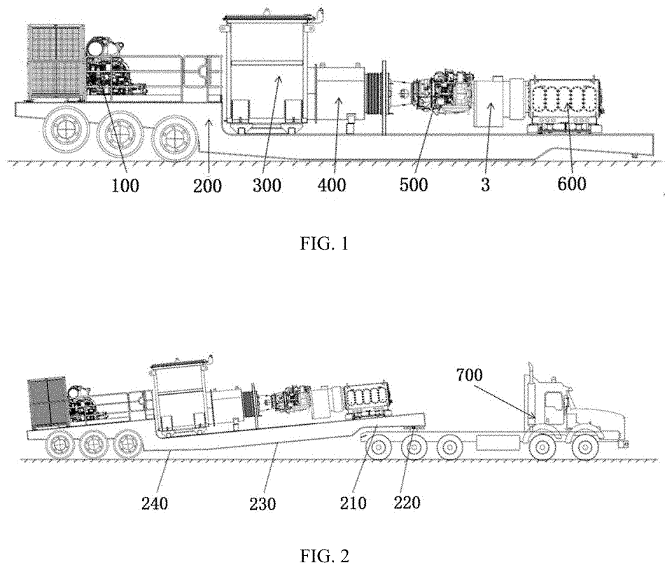

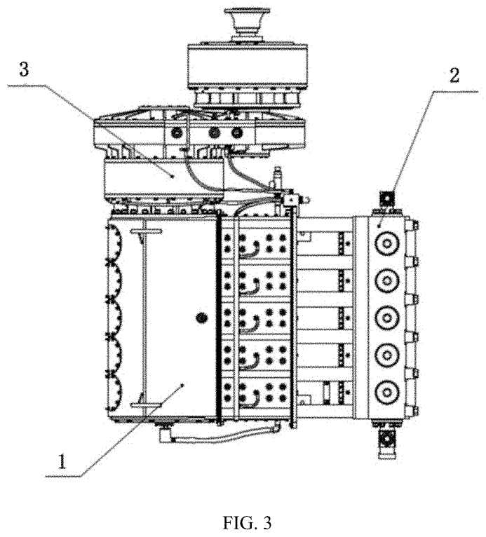

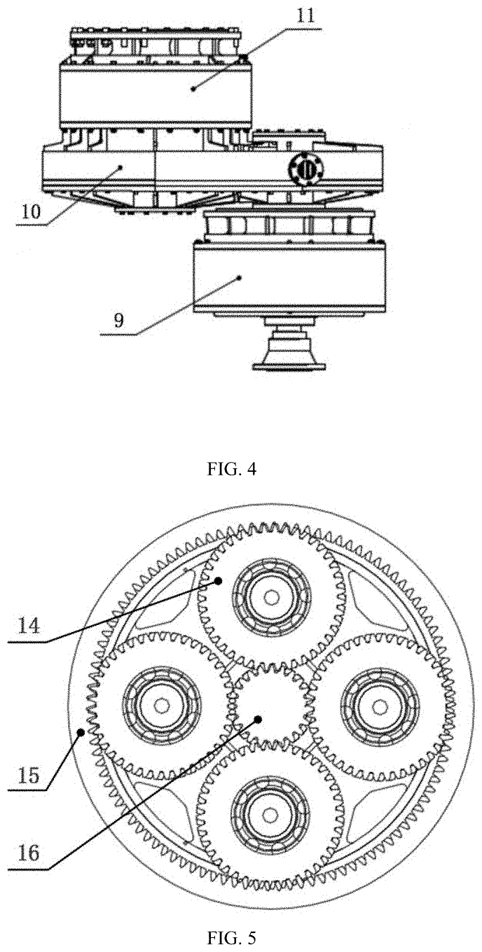

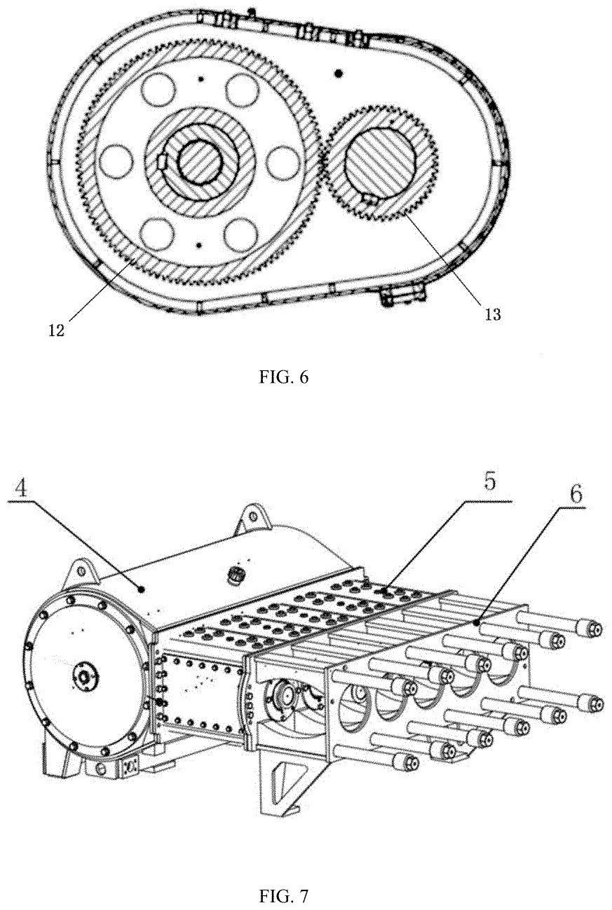

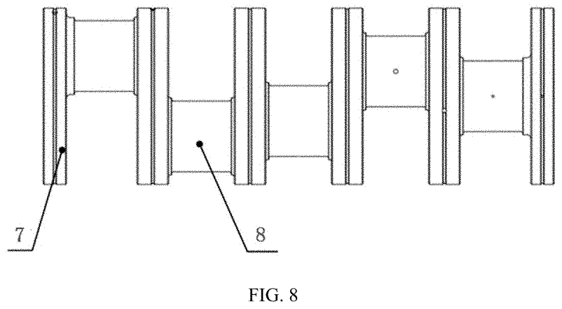

As shown in FIGS. 1 to 8, a semi-trailer-loaded turbine fracturing equipment, including a transporter 200, an exhaust system, a turbine engine 500 and a plunger pump 600. The turbine engine 500 is the power source for the power transmission system of the whole equipment, which is fueled by 100% natural gas directly, greatly reducing the use cost compared with the diesel consumption in diesel drive and the investment on gas generator sets of the electric drive fracturing equipment. Of course, the turbine engine 500 can also use 100% fuel oil as the fuel, preferably natural gas, which can reduce more fuel costs than fuel oil. The exhaust system is connected to an exhaust port of the turbine engine 500, an output end of the turbine engine 500 is connected to the plunger pump 600. The exhaust system includes an exhaust silencer 300 and an exhaust duct 400, the exhaust silencer 300 is connected to the exhaust port of the turbine engine 500 through the exhaust duct 400. The exhaust duct 400 is used to direct the exhaust of the turbine engine 500 into the exhaust silencer 300, which can reduce the noise of the exhaust. The exhaust system, the turbine engine 500 and the plunger pump 600 are disposed in a straight line along the transmission direction of power. In other words, the exhaust silencer 30, the exhaust duct 400, the turbine engine 500 and the plunger pump 600 are disposed in a straight line along the transmission direction of power, so as to avoid excessive transmission loss, thus ensuring efficient transmission performance, further lowering the center of gravity of the equipment compared with the upper and lower structure setting in the existing equipment, thus achieving better safety and stability, and the transportation is more convenient, the structure is simpler. The transporter 200 is used to support the exhaust system, the turbine engine 500 and the plunger pump 600. The plunger pump 600 includes a power end assembly 1, a hydraulic end assembly 2 and a reduction gearbox assembly 3. One end of the power end assembly 1 is connected to the hydraulic end assembly 2, the other end of the power end assembly 1 is connected to the reduction gearbox assembly 3. The reduction gearbox assembly 3 includes a planetary reduction gearbox and a parallel reduction gearbox 10, the planetary reduction gearbox is used in conjunction with the parallel reduction gearbox 10 with a transmission ratio of 60:1 to 106:1. The turbine engine 500 is connected to the reduction gearbox assembly 3. The reduction gearbox assembly 3 is used to slow down and increase the torque of the power output of the turbine engine 500, and then drives the plunger pump 600 to work. The transporter 200 is further provided with components such as battery wires, a fuel tank, a lubricating oil tank, a hydraulic oil tank and the like, providing oil and support for the up-loading components such as the turbine engine 500, the plunger pump 600 and the like.

There are two planetary reduction gearboxes, including a first planetary reduction gearbox 9 and a second planetary reduction gearbox 11. One end of the first planetary reduction gearbox 9 is connected to the crankshaft 7 of the power end assembly 1, the other end of the first planetary reduction gearbox 9 is connected to the parallel reduction gearbox 10, the other end of the parallel reduction gearbox 10 is connected to the second planetary reduction gearbox 11, and the other end of the second planetary reduction gearbox 11 is connected to the transmission shaft of the turbine engine 500. In working state, the kinetic energy transferred by the transmission shaft of the turbine engine 500 is decelerated by the second planetary reduction gearbox 11 for the first time, decelerated by the parallel reduction gearbox 10 for the second time, and finally decelerated by the first planetary reduction gearbox 9 for the third time.

The transmission ratio of the reduction gearbox assembly 3 is changed to elevate the maximum input speed (increasing from the current 2100 rpm to 16000 rpm). The connection between the current turbine engine 500 and the plunger pump 600 through two reduction gearboxes and one transmission shaft is improved so that the turbine engine 500 can be directly connected to the reduction gearbox assembly 3 on the plunger pump 600, which not only satisfies the reduction requirements, but also simplifies the structure of the whole fracturing equipment, of which the length is shorten, the transportation is convenient, the investment cost is decreased, and the maintenance is easy.

The planetary reduction gearbox includes one sun gear 16, four planetary gears 14 and one gear ring 15. The four planetary gears 14 form a planetary gear mechanism, the sun gear 16 is located at the center of the planetary gear mechanism, the planetary gears 14 and the adjacent sun gear 16 and gear ring 15 are in a normally engaged state. The planetary reduction gearbox uses four evenly distributed planetary gears 14 to transmit motion and power simultaneously. The centrifugal inertia force generated from the revolution of the four planetary gears 14 offsets the radial component of a counterforce between the tooth contours, to reduce the force on the main shaft and achieve high power transmission. The parallel reduction gearbox 10 includes a pinion 13 and a bull gear 12, the pinion 13 is coaxial with the sun gear 16 of the first planetary reduction gearbox 9, and the bull gear 12 is coaxial with the sun gear 16 of the second planetary reduction gearbox 11. The power is transmitted to the bull gear 12 through the pinion 13 in the parallel reduction gearbox 10 to realize the reduction.

An input angle of the reduction gearbox assembly 3 can be adjusted according to input requirements.

The other end of the power end assembly 1 is connected to the reduction gearbox assembly 3 through a spline or a flexible coupling.

The power end assembly 1 is designed to be a segmented structure so that the power end assembly 1 has a compact overall structure and can be manufactured more easily, the assembly and maintenance of the whole pump become more convenient, and meanwhile the processing cost is reduced. The power end assembly 1 includes a crankcase 4, a crosshead case 5 and a spacer frame 6, one end of the crosshead case 5 is connected to the crankcase 4, the other end of the crosshead case 5 is connected to the spacer frame 6; the hydraulic end assembly 2 is disposed at one end of the spacer frame 6 and is connected to the crankcase 4 through bolts sequentially passing through the spacer frame 6 and the crosshead case 5; the reduction gearbox assembly 3 is connected to the crankcase 4 through bolts, a crankshaft 7 in the crankcase 4 is forged from alloy steel and includes six axle journals 7 and five bellcranks 8, one bellcrank 8 is disposed between every two adjacent axle journals 7, that is a design of five cylinder structure. The design of five cylinder structure increases the output displacement of the plunger pump 600, and compared to a three cylinder pump, the five cylinder pump operates smoothly without vibration, thus reducing the vibration of the whole pump and prolonging its service life; and the distance between the center of rotation of the bellcrank 8 and the center of rotation of the crankshaft 7 is 120 to 160 mm. The distance between the center of rotation of the bellcrank 8 and the center of rotation of the crankshaft 7 is further investigated to increase the maximum power of the plunger pump 600 to 5000-7000 hp, so that the plunger pump 600 can output a higher pressure, i.e., provide a technical support for a long stroke, the stroke can reach 10-12 inches. A large displacement of the operation can be achieved, meanwhile the number of strokes of the pump is reduced, thereby extending the service life of the components.

The transporter 200 includes a chassis which is provided with a transport section, a bearing section and a lapping section which are connected in sequence; while the turbine fracturing equipment is in working state, the bearing section of the chassis can contact with the ground, while the turbine fracturing equipment is in transport state, the bearing section of the chassis does not contact with the ground.

The transporter 200 includes wheels and axles, the wheels are disposed at both ends of the axles, the axles are connected to the chassis, the number of the axles is 3 or above to ensure a sufficient bearing capacity. The axles are disposed at the transport section of the chassis.

While the turbine fracturing equipment is in working state, the bottom of the bearing section of the chassis is at the same level as the bottom of the wheels. The bottom itself of the bearing section is a horizontal surface 230 plus a slope surface 240, while in working state, the horizontal surface 230 at the bottom of the bearing section fully contact with the ground, increasing the stability of the equipment in operations. The slope surface 240 allows the raised chassis to be lifted off the ground for easy walking when the turbine fracturing equipment is in transport state.

The bottom of the lapping section is provided with a bevel 210 which is provided with a bulge 220. While the turbine fracturing equipment is in transport state, the bevel 210 can be used in conjunction with external towing equipment, the bulge 220 assists in fixing the transporter 200 and preventing the transporter 200 from separating from the external towing equipment. The external towing equipment may be a tractor 700, and the bulge may be a traction pin used in conjunction with the tractor 700.

The transporter 200 is provided with a hydraulic power unit 100 which is used to drive the hydraulic system on the turbine fracturing semi-trailer. The hydraulic system includes a hydraulic pump, a hydraulic motor, various valves, a hydraulic oil tank, a hydraulic oil radiator, and the like, (the hydraulic system is mainly used to drive the fuel pump of the turbine engine 500, the starting motor of the turbine engine 500, the lubrication system of the power end assembly 1 of the plunger pump 600, the lubrication system of the reduction gearbox assembly 3 of the plunger pump 600, and various oil radiators, and the like).

The hydraulic power unit 100 is driven by a diesel engine or driven by an electric motor.

The transporter 200 is provided with a cooling system which cools the oil used on the turbine fracturing semi-trailer. The oil used includes the engine oil for the turbine engine 500, hydraulic oil, the lubricating oil for the plunger pump 600, and the like.

It will be appreciated to persons skilled in the art that the present invention is not limited to the foregoing embodiments, which together with the context described in the specification are only used to illustrate the principle of the present invention. Various changes and improvements may be made to the present invention without departing from the spirit and scope of the present invention. All these changes and improvements shall fall within the protection scope of the present invention. The protection scope of the present invention is defined by the appended claims and equivalents thereof.

1. A semi-trailer-loaded turbine fracturing equipment, wherein the turbine fracturing equipment comprises a transporter, an exhaust system, a turbine engine and a plunger pump, the exhaust system is connected to an exhaust port of the turbine engine, an output end of the turbine engine is connected directly to the plunger pump, the transporter is used to support the exhaust system, the turbine engine and the plunger pump, the plunger pump comprises a power end assembly, a hydraulic end assembly and a reduction gearbox assembly, one end of the power end assembly is connected to the hydraulic end assembly, the other end of the power end assembly is connected to the reduction gearbox assembly, the reduction gearbox assembly comprises two planetary reduction gearboxes and a parallel reduction gearbox, the planetary reduction gearboxes are used in conjunction with the parallel reduction gearbox with a transmission ratio of 60:1 to 106:1.

2. The semi-trailer-loaded turbine fracturing equipment according to claim 1, wherein the exhaust system, the turbine engine and the plunger pump are disposed in a straight line along a transmission direction of power.

3. The semi-trailer-loaded turbine fracturing equipment according to claim 1, wherein the two planetary reduction gearboxes comprise a first planetary reduction gearbox and a second planetary reduction gearbox, one end of the first planetary reduction gearbox is connected to the power end assembly, the other end of the first planetary reduction gearbox is connected to the parallel reduction gearbox, and the other end of the parallel reduction gearbox is connected to the second planetary reduction gearbox.

4. The semi-trailer-loaded turbine fracturing equipment according to claim 3, wherein the planetary reduction gearbox comprises one sun gear, four planetary gears and one gear ring, the four planetary gears form a planetary gear mechanism, the sun gear is located at the center of the planetary gear mechanism, the planetary gears and the adjacent sun gear and gear ring are in a normally engaged state, the parallel reduction gearbox comprises a pinion and a bull gear, the pinion is coaxial with the sun gear of the first planetary reduction gearbox, and the bull gear is coaxial with the sun gear of the second planetary reduction gearbox.

5. The semi-trailer-loaded turbine fracturing equipment according to claim 1, wherein an input angle of the reduction gearbox assembly can be adjusted according to input requirements.

6. The semi-trailer-loaded turbine fracturing equipment according to claim 1, wherein the other end of the power end assembly is connected to the reduction gearbox assembly through a spline or a flexible coupling.

7. The semi-trailer-loaded turbine fracturing equipment according to claim 1, wherein the power end assembly comprises a crankcase, a crosshead case and a spacer frame, one end of the crosshead case is connected to the crankcase, the other end of the crosshead case is connected to the spacer frame, the hydraulic end assembly is disposed at one end of the spacer frame and is connected to the crankcase through bolts sequentially passing through the spacer frame and the crosshead case; the reduction gearbox assembly is connected to the crankcase through bolts, a crankshaft in the crankcase is forged from alloy steel and comprises six axle journals and five bellcranks, one bellcrank is disposed between every two adjacent axle journals, and the distance between the center of rotation of the bellcrank and the center of rotation of the crankshaft is 120 to 160 mm.

8. The semi-trailer-loaded turbine fracturing equipment according to claim 1, wherein the transporter comprises a chassis which is provided with a transport section, a bearing section and a lapping section which are connected in sequence; while the turbine fracturing equipment is in a working state, the bearing section of the chassis can contact with the ground, while the turbine fracturing equipment is in a transport state, the bearing section of the chassis does not contact with the ground.

9. The semi-trailer-loaded turbine fracturing equipment according to claim 8, wherein the transporter comprises wheels and axles, the wheels are disposed at both ends of the axles, the axles are connected to the chassis, and the number of the axles is 3 or above.

10. The semi-trailer-loaded turbine fracturing equipment according to claim 9, wherein while the turbine fracturing equipment is in a working state, the bottom of the bearing section of the chassis is at the same level as the bottom of the wheels.

11. The semi-trailer-loaded turbine fracturing equipment according to claim 8, wherein the bottom of the lapping section is provided with a bevel which is provided with a bulge, while the turbine fracturing equipment is in a transport state, the bevel can be used in conjunction with external towing equipment, the bulge assists in fixing the transporter and preventing the transporter from separating from the external towing equipment.

12. The semi-trailer-loaded turbine fracturing equipment according to claim 1, wherein the transporter is provided with a hydraulic power unit which is used to drive the hydraulic system on the turbine fracturing semi-trailer.

13. The semi-trailer-loaded turbine fracturing equipment according to claim 12, wherein the hydraulic power unit is driven by a diesel engine or driven by an electric motor.

14. The semi-trailer-loaded turbine fracturing equipment according to claim 1, wherein the transporter is provided with a cooling system which cools the oil used on the turbine fracturing semi-trailer.
